(19) United States
(12) Patent Application Publication
(10) Pub. No.: US 2020/0250780 A1
(43) Pub. Date: Aug. 6, 2020

(54) Decentralized Autonomous Evaluation Engine for Intellectual Property Assets

(71) Applicant: George KARYPIS, Bloomington, MN (US)

(72) Inventors: ERICH LAWSON SPANGENBERG, PARIS (FR); DANIEL LAWRENCE BORK, EAST KINGSTON, NH (US); PASCAL ASSELOT, PARIS (FR); GEORGE KARYPIS, BLOOMINGTON, MN (US)

(21) Appl. No.: 16/758,400

(22) PCT Filed: Dec. 6, 2018
(86) PCT No.: PCT/US18/64186

§ 371 Date: Apr. 23, 2020

Related U.S. Application Data
(63) Continuation-in-part of application No. 16/758,375.
Application No. 16/758,375 is a continuation-in-part of application No. 16/758,384, filed on Apr. 22, 2020.
Application No. 16/758,384 is a continuation-in-part of application No. 16/758,392, filed on Apr. 22, 2020.
Application No. 16/758,392 is a continuation-in-part of application No. 16/758,395, filed on Apr. 22, 2020.
Application No. 16/758,395 is a continuation-in-part of application No. 16/758,398, filed on Apr. 23, 2020.
(60) Provisional application No. 62/607,919, filed on Dec. 20, 2017.
(60) Provisional application No. 62/610,265, filed on Dec. 25, 2017.
(60) Provisional application No. 62/575,610, filed on Oct. 23, 2017.
(60) Provisional application No. 62/576,516, filed on Oct. 24, 2017.
(60) Provisional application No. 62/577,253, filed on Oct. 26, 2017.
(60) Provisional application No. 62/579,172, filed on Oct. 31, 2017.
(60) Provisional application No. 62/579,347, filed on Oct. 31, 2017.
(60) Provisional application No. 62/582,976, filed on Nov. 8, 2017.
(60) Provisional application No. 62/588,350, filed on Nov. 19, 2017.
(60) Provisional application No. 62/588,932, filed on Nov. 21, 2017.
(60) Provisional application No. 62/622,922, filed on Jan. 28, 2018.
(60) Provisional application No. 62/622,987, filed on Jan. 29, 2018.
(60) Provisional application No. 62/622,994, filed on Jan. 29, 2018.
(60) Provisional application No. 62/660,946, filed on Apr. 21, 2018.
(60) Provisional application No. 62/672,697, filed on May 17, 2018.
(60) Provisional application No. 62/685,299, filed on Jun. 15, 2018.
(60) Provisional application No. 62/685,937, filed on Jun. 16, 2018.
(60) Provisional application No. 62/685,960, filed on Jun. 16, 2018.
(60) Provisional application No. 62/689,241, filed on Jun. 24, 2018.
(60) Provisional application No. 62/695,002, filed on Jul. 7, 2018.
(60) Provisional application No. 62/695,126, filed on Jul. 8, 2018.
(60) Provisional application No. 62/696,357, filed on Jul. 11, 2018.

(51) Int. Cl. G06Q 50/18; G06Q 40/06; G06N 3/04; H04L 9/06; H04L 9/08

(52) U.S. Cl. CPC G06Q 50/184; G06Q 40/06; G06N 3/0427; H04L 9/0643; G06Q 2220/00; H04L 2209/38; H04L 2209/56; H04L 2209/60; H04L 9/0825

(57) ABSTRACT

A decentralized network, the network capable of deploying an automated system and method for determining the value of an intangible asset or intellectual property and developing a fair remuneration structure for licensing or purchasing the intangible asset or intellectual property by comparison to a dissected value of prior licensing and sale of transactions.

Valuation determinants, including remuneration structures from prior transactions, registrability, and ability to withstand challenge are extracted, analyzed and weighted and loaded into a knowledge base. The knowledge base growing based on a decentralized and public facing approach. Remuneration structures are normalized and used to train predictive algorithms based on a market analysis and previous transactions. The algorithms are able both to learn from previous transactions and to assess the importance of particular valuation determinants in determining the value under particular circumstances. An equitable rate for a new transaction is determined by examining the knowledge base and varying the valuation determinants.

### PRIORITY CLAIMS

This application claims the benefit of U.S. Provisional Patent Application No. 62/607,919, filed Dec. 20, 2017. This application also claims the benefit of U.S. Provisional Patent Application No. 62/610,265, filed Dec. 25, 2017. This application also claims the benefit of International Patent Application Number PCT/US2018/56690, filed on Oct. 19, 2018, which claims the benefit of U.S. Provisional Patent Application No. 62/575,610, filed Oct. 23, 2017. This application also claims the benefit of International Patent Application Number PCT/US2018/56884, filed on Oct. 22, 2018, which claims the benefit of U.S. Provisional Patent Application No. 62/576,516, filed Oct. 24, 2017. This application also claims the benefit of International Patent Application Number PCT/US2018/57062, filed on Oct. 23, 2018, which claims the benefit of U.S. Provisional Patent Application No. 62/577,253, filed Oct. 26, 2017, U.S. Provisional Patent Application No. 62/579,172, filed Oct. 31, 2017, and U.S. Provisional Patent Application No. 62/579,347, filed Oct. 31, 2017. This application also claims the benefit of International Patent Application Number PCT/US2018/59174, filed on Nov. 5, 2018, which claims the benefit of U.S. Provisional Patent Application No. 62/582,976, filed Nov. 8, 2017. This application also claims the benefit of International Patent Application Number PCT/US2018/61448, filed on Nov. 16, 2018, which claims the benefit of U.S. Provisional Patent Application No. 62/588,350, filed Nov. 19, 2017, and U.S. Provisional Patent Application No. 62/588,932, filed Nov. 21, 2017. This application also claims the benefit of U.S. Provisional Patent Application No. 62/622,922, filed Jan. 28, 2018. This application also claims the benefit of U.S. Provisional Patent Application No. 62/622,987, filed Jan. 29, 2018. This application also claims the benefit of U.S. Provisional Patent Application No. 62/622,994, filed Jan. 29, 2018. This application also claims the benefit of U.S. Provisional Patent Application No. 62/660,946, filed Apr. 21, 2018. This application also claims the benefit of U.S. Provisional Patent Application No. 62/672,697, filed May 17, 2018. This application also claims the benefit of U.S. Provisional Patent Application No. 62/685,299, filed Jun. 15, 2018. This application also claims the benefit of U.S. Provisional Patent Application No. 62/685,937, filed Jun. 16, 2018. This application also claims the benefit of U.S. Provisional Patent Application No. 62/685,960, filed Jun. 16, 2018. This application also claims the benefit of U.S. Provisional Patent Application No. 62/689,241, filed Jun. 24, 2018. This application also claims the benefit of U.S. Provisional Patent Application No. 62/695,002, filed Jul. 7, 2018. This application also claims the benefit of U.S. Provisional Patent Application No. 62/695,126, filed Jul. 8, 2018. This application also claims the benefit of U.S. Provisional Patent Application No. 62/696,357, filed Jul. 11, 2018, each of which is incorporated herein by reference.

### FIELD OF THE INVENTION

This invention deals with a decentralized method of autonomously valuing Intellectual Property.

### BACKGROUND

The present invention relates to the valuation of intangible assets, including intellectual property, more particularly to an automated system that predicts a fair rate for the sale or licensing of an intellectual property or intangible asset based on an assessment of other transactions, the registrability of the asset, and the ability of the asset to withstand a challenge.

Many organizations and individuals need to calculate license fees and royalty rates or perform intellectual property valuations. Lawyers and accountants need to calculate license fees and royalty rates and value intellectual property in drawing up certain documents and calculating the asset structure of a company. Banks need to be able to value intellectual property as part of organizational intangible assets in order to better calculate net worth and establish lending risk, and thus rate, and borrowing power. Insurers need to perform valuations in order to calculate actuarial values for coverage.

A significant amount of skill and effort is required to research and gather the required background information and accurately calculate license fees and royalty rates and value intellectual property. In general, heavy reliance is mad on valuation professionals with direct knowledge of the specific area of application and, sometimes, valuations are simply loose estimates based on heuristics particularly where there is insufficient knowledge of the application domain. The process is complicated by the fact that a particular valuation is often inextricably linked to the organization or industry in which it appears and the fact that expert understanding of a particular industry is required to perform a fair valuation.

There are three generally accepted valuation approaches. The cost approach quantifies the replacement cost of future service capability; the income approach quantifies the income producing capability and the market approach bases the estimation on a consensus of what others perceive the value to be, as indicated by arm's length transactions in a free market. Although the market approach is the most direct and easily understood valuation method, it is seldom used as it requires, among others, an active public market and exchange of comparable intangible assets or intellectual property in the same or very similar area of application and these are seldom known (or existent).

Valuators often spend a significant amount of time and effort gleaning data from financial statements which, while providing a consistent and reliable framework from which to work, are also unreliable predictors of value. This is mainly because financial statements are generally skewed heavily or exclusively in favor of tangible assets and therefore are unreliable predictors of intangible asset or intellectual property value. In the absence of a counterbalancing force, as in an arm's length business negotiation process, appraiser bias may also skew a particular valuation in one or other direction, depending on the purpose for which the valuation will be used.

Several companies sell books, professional journals, access to electronic databases, information retrieval or alerting services and software systems, that include algorithmic estimation and modeling applications, to assist with license fee and royalty rate determination and with intellectual property valuation. These are generally based on the cost or income approach. Much of the information regarding licensing transactions is publicly available and, in addition, many organizations maintain private licensing transaction databases.

At present, valuators mostly use the income approach to intellectual property valuation and require an extensive information gathering effort before the valuation can be performed. This is expensive, time-consuming and requires specialist skills. Although databases of transaction information do exist, they are generally used as repositories of information and not as the basis for artificial intelligence (AI) techniques such as artificial neural networks, concept matching or expert system analysis. Because of transaction information is largely incomparable, valuations based on prior transactions are rare, and legal precedents of little value. In addition, there are few valuation standards or generally accepted procedures that result in an objective assessment. As a result, valuations are often the result of a business negotiation process and not necessarily based on an understanding of the actual market value. This issue is increasingly becoming the norm as a result of the emergence of organizations whose main (or even sole) value is in intellectual property, with the consequent increased requirement for licensing transactions and payment of royalties. Information age managers are increasingly becoming aware of the shortfalls of conventional methods for performing valuations and increasingly require techniques that can effectively value intangible assets and intellectual property.

The present invention seeks to provide an automated method and system for accurately valuing intellectual property assets, including determining their sale price, license fees or royalty rates.

### SUMMARY OF THE INVENTION

A central aspect of the current invention is that it envisions a decentralized network that can autonomously value intellectual property. This decentralized network is known as a blockchain network. The “blockchain” or “block chain” is a data structure that stores a list of transactions and can be thought of as a distributed electronic ledger that records transactions between source identifier(s) and destination identifier(s). Every transaction is “to” a destination identifier that is associated with a public/private key pair. In creating a new transaction, outputs from other, prior transactions that are to the “from” address (which may be multiple different addresses derived from the same private key) are used as inputs for this new transaction. The new transaction is then encumbered with the public key associated with the “to” destination identifier. In other words, outputs from prior blockchain transactions are used as inputs for new transactions that are then signed using the public key associated with the destination address. The new blockchain transaction is then submitted to the blockchain. Once on the blockchain multiple such transactions are bundled into a block and the block is linked to a prior block in the “blockchain.” Computer nodes of the distributed system then maintain the blockchain and validate each new block (along with the transactions contained in the corresponding block). The techniques described herein make use of blockchain technology to address one or more problems with the conventional database systems

Blockchain technology holds great promise for a range of industries and business cases, including the patent asset class. That is because a Blockchain can be viewed as a type of shared database, the contents of which are verified and agreed upon by a network or independent actors. For a new piece of data (such as the owner of a newly issued patent) to be added to the Blockchain, the independent verifiers must come to consensus on its validity.

Because each new set of transactions (a “block”) is cryptographically linked to the previous block, it is extraordinarily difficult to change data stored in a Blockchain and any such change would be readily detectable. Thus, blockchains are widely considered to be immutable and thus can serve as a record of proof of ownership.

When transacting in a Blockchain platform, each user makes use of a public address (needed for other actors in the network to send a transaction to that user), and a cryptographically paired “private key.” Private keys are used to sign transactions digitally, a form authentication to ensure that a given user has genuinely generated a transaction.

Blockchain is a relatively new technology. The first “real world” implementations of Blockchain, Bitcoin, envisioned by Satoshi Nakamoto launched in 2009. The Ethereum Blockchain was released in 2015. In addition to the distributed ledger capability of the Bitcoin Blockchain, the Ethereum Blockchain allows so-called “smart contracts,” which are programs stored in the Ethereum Blockchain that can act autonomously to execute sophisticated transactions.¹ “Ethereum Whitepaper,” http://github.com/ethereum/wiki/wiki/white-paper, 2016

Blockchain data transfer is currently considered one the most secure technologies for digital asset transfer due to its distributed nature and use of sophisticated cryptography. Smart contracts, therefore, offer a potential solution for the management of patent transactions via the introduction of a universal, distributed ledger that does not require trust in a single third party.

The Bitcoin blockchain is limited to sets of simple information and scripts such as transaction details and conditioning a transaction on a minimum number of signatories. It was therefore argued that for a virtual currency to truly revolutionize trade it must also provide built-in means for facilitating complex contracts and deals with the currency.

Project Ethereum builds upon Bitcoin. Not only does it allow decentralized data storage in its blockchain, Ethereum also allows storing program code on its blockchain and running it concurrently by any number of network members. By predicating release of funds upon verifiable occurrences, Ethereum enables smart contract functionality.

Basically, a network member uploads a computer program written in one of several permitted languages to the blockchain. The member may then condition the release of an amount of ETH (the currency underlying Ethereum) upon reaching the end of this program. Various network members thereafter run the program concurrently and reach a consensus on the resulted output.

The scripting languages in Ethereum or the IBM Hyperledger are Turing complete as they can implement any logic rules and initiate any calculations available.

This feature allows any member to issue and trade with a custom virtual currency upon the Ethereum network. For the sake of clarity, a custom virtual currency issued and based upon another virtual currency is referred to as a Token. A Token may have various uses. While a certain Token will represent money, another Token will represent club member points or frequent flyer points. Tokens may be traded for ETH or for any other commodities and Tokens via the Ethereum or the IBM Hyperledger network.

Before Ethereum or the IBM Hyperledger, a person was required to launch a new blockchain utilizing custom user clients and mining algorithm, in order to issue a custom decentralized virtual currency. The emergence of the Ethereum or the IBM Hyperledger network allows easy issuance of Tokens with minimal setup.

It should be mentioned that after Ethereum, several other virtual currency networks implementing smart contracts were established. Prominent examples include the IBM Hyperledger, Lisk and RootStock.

The proposed method envisions a tool powered by smart contracts and combines several approaches from the payment industries into a blockchain format. With blockchain as the core technology, the present invention further proposes a decentralized platform (“IPWe Platform”) containing a valuation engine (“IPwe valuation engine”) that can be utilized to value intellectual property assets.

The present invention leverages various publicly available databases and private information related to intellectual property transaction and compiles the information into one decentralized network.

It matches not only an intellectual property asset with a similar asset, but also a potential transaction with similar transactions.

It utilizes a neural network running on a blockchain, to numerically rate specific categories regarding an intellectual property asset, the categories including historical data of: similar transactions, the likelihood of registrability, and the ability to withstand third party challenges. Further categories including input from third parties related to the necessity, popularity, and benefit of an IP asset.

The neural network autonomously deploys a smart contract, the contract including code that normalizes ratings and presents an analysis and overall value metric of an intellectual property asset to a requester.

Wherein a user decides to act on a specific valuation by either purchasing or licensing some intellectual property, the blockchain network can deploy a smart contract containing code, that when executed results in the exchange of rights related to the intellectual property asset.

### BRIEF DESCRIPTION OF THE DRAWINGS

FIG. 1 is a structural diagram showing the interconnection of nodes in a blockchain network.

FIG. 2 is a flow diagram showing one embodiment of the present invention.

FIG. 3 is a flow diagram depicting another embodiment of the present invention.

FIG. 4 is a diagram depicting another embodiment of the present invention.

### DETAILED DESCRIPTION

A significant portion of world R&D efforts are centered on standards (communication and broadcasting protocols, media encoding & decoding . . . ). Research entities join development efforts under the lead of Standard Setting Organizations (or SSOs, such as 3GPP for mobile communications) and generally pledge to license the patents covering their contributions under Fair, Reasonable and Non-Discriminatory terms (aka FRAND).
a. Stakes are high (for example, the mobile phone market only is close to USD 500B and is highly dependent on standards)
b. Players are global (from the US and Europe to Japan with Korea and now China as emerging powers)
c. Yet, no market valuation mechanism is available outside of the expensive, time consuming judicial system
d. The inefficiency of the SEP market is huge deterrent for SMEs to enter the standard driven industries (communications, IoT . . . )

The Standard Essential Patents or SEPs, are therefore the best illustration of the problems caused by the difficulty to properly value patents. The European Commission and various stakeholders have allocated efforts to address the SEP issue1 (Cf). In this space too, AI technologies can fight the inefficiency of the patent system. Providing a proper valuation framework for SEP requires to add another layer to our current ambitions: the assessment of essentiality, i.e. to assess whether a patent is necessarily infringed by a user of the standard specification. This added complexity demands the help of experts in both patent infringement and technical standards. A specific research component has been identified for SEP valuation.

In order evaluate intellectual property (IP), such as calculating a sale price, a license fee or royalty rate using a market-based approach, it is necessary according to the method and system of the present invention to consider the remuneration structure in previous transactions, including such forms of remuneration as upfront payments, milestone payments, license fees and royalty rates. The present invention utilizes a decentralized network to value intellectual property.

The present invention seeks to deploy a novel approach to patent valuation based on:
a. An Artificial Intelligence engine that has been trained on patents for the past 10 years, battled tested and contributed to the generation of $500M USD in patent monetization.
b. The aggregation of historical data from the track records of field leaders.
c. A new method to collect data from industry players, preserving confidentiality and ownership.
d. Continuous training of the AI, the Valuation Engine will leverage on an existing AI core trained on patents and will be taught by vast pools of data points. The Valuation Engine is not intended to be monetized but will serve as a key enabler for a transaction platform and be available without charge to third parties. Future transactions will be continuously fed into the system and contribute to the on-going relevance of Valuation Engine.

This decentralized network will require at least one server, a processor, and at least one networking interface (“Network” or “IPWe Platform” or “IPWe”). Such a Network will allow the connection of user devices through the Internet. The Network itself will consist of at least one server, which will host a webpage, that when executed, will allow users to access a portal and be identified cryptographically using a private key and public key. The web portal or other network connected device will provide a platform to connect a patent owner with other stakeholders in the patent process.

In order for a decentralized system to function, one embodiment of the present invention envisions a patent mitigation insurance ecosystem functioning on a blockchain network.

In one embodiment of the present invention, the decentralized network is a blockchain network. Blockchain technology (sometimes simply referred to as a blockchain) was developed and has been used in certain digital currency implementations. An example implementation and corresponding blockchain techniques are described in a 2008 article by Satoshi Nakamoto, called “Bitcoin: A Peer-to-Peer Electronic Cash System,” the entire contents of which are hereby incorporated by reference. With that being said, in certain embodiments discussed herein, the blockchain may be privately hosted (e.g., where all member nodes are run and provided by the same entity or a controlled group of entities). In certain example embodiments, the blockchain may be a distributed blockchain, such as the one provided by the bitcoin network. Thus, the term blockchain as used herein is not confined to the so-called blockchain that is only used for the bitcoin cryptographic currency.

The blockchain is a data structure that stores a list of transactions and can be thought of as a distributed electronic ledger that records transactions between source identifier(s) and destination identifier(s). Every transaction is “to” a destination identifier that is associated with a public/private key pair. In creating a new transaction, outputs from other, prior transactions that are to the “from” address (which may be multiple different addresses derived from the same private key) are used as inputs for this new transaction. The new transaction is then encumbered with the public key associated with the “to” destination identifier. In other words, outputs from prior blockchain transactions are used as inputs for new transactions that are then signed using the public key associated with the destination address. The new blockchain transaction is then submitted to the blockchain. Once on the blockchain multiple such transactions are bundled into a block and the block is linked to a prior block in the “blockchain.” Computer nodes of the distributed system then maintain the blockchain and validate each new block (along with the transactions contained in the corresponding block). The techniques described herein make use of blockchain technology to address one or more problems with the conventional database systems to provide a pooled resource for Patent owners and other stake holders.

A computer, network, or blockchain, may deploy a smart contract. A smart contract is computer code that implements transactions of a contract. The computer code may be executed in a secure platform (e.g., an Ethereum platform, IBM Hyperledger platform) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes initializing the smart contract and its state. The state of a smart contract is stored persistently in the blockchain (e.g., via a Merkle tree). When a transaction is recorded against a smart contract, a message is sent to the smart contract and the computer code of the smart contract executes to implement the transaction (e.g., debit a certain amount from the balance of an account, transfer the ownership of a patent). The computer processes the code and ensures that all the terms of the contract are complied with before the transaction is recorded in the blockchain. For example, a smart contract may request an exchange of one type of cryptocurrency token to another. The computer executes code to determine the exchange rate and transfers the correct amount of tokens to and from the correct accounts.

The blockchain network may include multiple computers, networks, links, and databases. Miners may manage the blockchain, whereas the managing may include, for example, validating a smart contract and/or transaction according to the smart contract, updating the blockchain with a validated smart contract and update the blockchain with a transaction that is executed according to the smart contract, determine that a suggested smart contract is invalid, determine that a transaction is not according to a smart contract, and the like.

In some embodiments, a smart contract may be accompanied by a digital certificate, or a digital signature which contains information regarding the source of the transaction. The computer, network, or blockchain will validate this information and determine the authenticity of the source of the transaction prior to deploying the smart contract.

The smart contract may determine the rules for evaluating a token price and an initial status of the token (such as the reserve of the token) and any other rules that should be applied during a transaction.

The platform itself can construct a smart contract in real time based on inputs from an inventor or patent holder. In one embodiment, the inventor submits the patent application, and the network uses an analysis engine to generate a report regarding the likelihood of patentability based on several criteria, including patentable nature of the invention, the status of prior art, and the novelty of the inventive step. The platform further provides a user to express interest in insurance, and provides a rate and insurance premium price using FIAT currency and virtual currency. The user can select the options that seem most beneficial to the user at that time.

In evaluating IP on the decentralized database, it is important to note that, No two transactions are exactly the same and therefore an extensive amount of data related to prior transactions is needed in order to provide sufficient comparison information in order to perform accurate valuations. In addition, the collection of data must be continuous to ensure that the valuation keeps up with the current market trends. The historical information also needs to be dissected and analyzed according to a predetermined scheme to produce a viable rating scheme.

Among others, transaction data will have to be dissected into the following categories:
a. Into what field the licensed IP fall; for example, is it a software product, a pharmaceutical process or product, a book or an electrical gadget?
b. Is the licensed IP a patent, design right, trademark, copyright or know-how?
c. In what countries has the IP been protected? This will directly relate to the amount (monetary) that has been spent by the licensor on protection.
d. Is the license exclusive or non-exclusive? Is it an assignment rather than a license? Was there an option to license or no option?
e. Is it a license from a non-profit organization to a “for profit” organization, or a license from a “for profit” organization to a “for profit” organization or from a “for profit” organization to a “not-for-profit” organization?
f. In what year was the license granted?
g. What is the territory of the license?
h. What is the country of the licensor and the country of the licensee?
i. How are the royalty rates paid under the license (timing of)? Are there any upfront payments or milestone payments?
j. What is the remaining life of the IP?
k. Is there ongoing support from the licensor?
l. Are there any regulatory issues?
m. What kind of third-party challenges have similar IP faced?
n. What is the likelihood that this IP will withstand similar challenges?
o. What makes this IP asset different from those that had previously faced challenges?
p. How crowded is the field?

The above information can all be obtained from content contained in licenses/agreements and extracted from a decentralized transactions network, which, when used with the software systems of the invention, can be used to calculate accurate license fees, royalty rates, and IP value.

However, there are other important factors including the influence of financial, market and industry determinants that heavily influence: determinations and valuations. Other important issues include the following:
a. How important is the license to the licensee's business?
b. How does the licensed IP fit into the licensee's current portfolio of IP is it central or peripheral?
c. Are there competing technologies? Is it a breakthrough technology? How aggressive is research in the licensed field?
d. How much was spent on developing the IP to be licensed?
e. What is the business of the licensor and the licensee? What is the size of the licensor and size of the licensee (relates to negotiating power)?
f. How well developed is the IP; is it embryonic or mature?
g. Is there more than one potential licensee in the market? If so, how many? What is their buying power?
h. What are the potential markets for the licensed IP and what is their potential (maximum) size?
i. What is the possible number of end-user applicants for the licensed IP?

The above lists are not exhaustive, and it is likely that other parameters will be important in specific industries or will become evident in time.

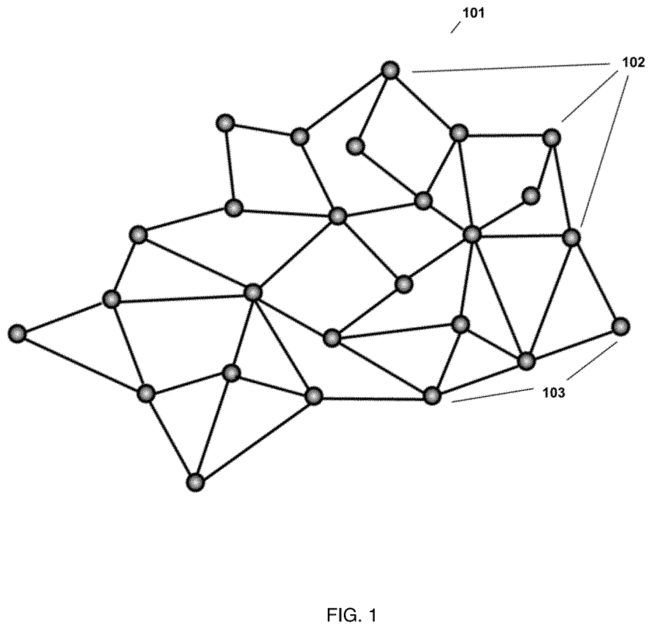

FIG. 1 depicts one aspect of the present invention. Specifically, the illustration shows the interconnection of each node 102 in a distributed decentralized network 101. In accordance with the preferred embodiment of the present invention, each node 102 in the distributed network 101 is directly connected to at least two other nodes 103. This allows each node 102 to transact with at least one other node 102 in the network.

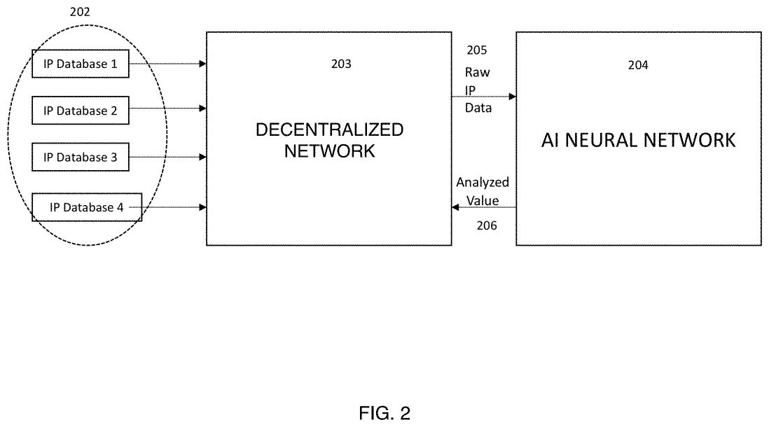

FIG. 2 which is represented by number 201, details one embodiment of the present invention, wherein any number of IP Databases 202 are connected to a decentralized network 203. The network is interlinked to a AI neural network 204. The decentralized network 203 passes IP Related data 205 to the AI neural network 204. The AI neural network passes analyzed value 206 of an IP asset back to the decentralized network.

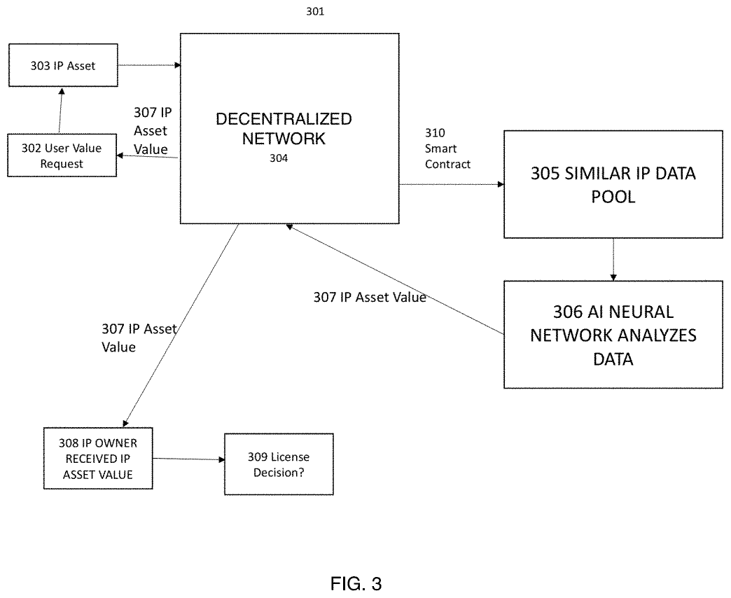

The market valuation method is generally explained by the following steps (see FIG. 3):

Analyze existing IP or technology transfer transactions
a. Determine the normalized value of either of:
b. the net license fee value of the intellectual property or technology; or
c. the sale price of the intellectual property or technology; or
d. the sale price of the business entity containing the intellectual property or intangible asset.
e. Evaluate the determinants contained in the licensing or sale agreement and evaluate the rating and weighting factors associated with the determinants
f. Determine the market value of the intellectual property or intangible asset and the market value multiple
g. Train the Artificial Neural Network Software Application
h. Input to neural network and train algorithms
i. Determine a New Remuneration Structure
j. Calculate an initial estimate of the market value from the technology and industry type and the applicable market value multiple
k. Input the known values for determinants and the weightings and ratings
l. Use the artificial neural network to predict and structure remuneration and licensing options.

In one embodiment, the artificial intelligence analyzes a variety of data to determine the value IP included in a sale or licensing agreement. The categories of data include:
a. All the territories in which the product or technology is licensed
b. The exclusivity of the agreement (Exclusive, Sole or Non-Exclusive)
c. The term of the agreement (number of years or perpetual)
d. The remaining life of the legal protection at the date of the agreement
e. Details of any restrictions on the license e.g. no sub-license or transfer
f. The general area in which the technology falls, e.g. biotechnology, Engineering
g. A brief description of the technology that is the subject of the licensing agreement
h. Any regulatory approval required to fully exploit the technology
i. The type of any legal protection afforded to the IP
j. The support provided by the Licensor for infringement
k. Ongoing support provided by the Licensor as part of the licensing agreement
l. Details of any other IP, know-how or confidential information transfers between Licensor and Licensee in the agreement
m. The amount and currency of any upfront payment
n. The amount, currency, frequency and duration of any milestone payments as well as details of the trigger event
o. The amount, currency, frequency and duration of any royalty payments.
p. The amount and worth of any share exchanges and Licensor Licensee
q. The value of any sale agreement concluded as part of the technology or IP exchange
r. Is the Licensor listed on a public exchange?
s. Is the Licensee listed on a public exchange?
t. The strength of the legal protection
u. The degree of enforceability of the legal protection
v. How much the Licensee's IP portfolio will increase in value due to addition of the licensed IP or technology
w. The goodness of fit between the licensed technology and the Licensee's existing IP portfolio
x. Any existing business relationship (excluding technology transfer) between Licensor and Licensee
y. Details of any previous technology, IP or confidential information transfers between Licensor and Licensee & relation to present agreement
z. The degree of maturity of the technology, ranging from embryonic to mature
aa. The cost of bringing the IP or technology to market
bb. The potential competition measured in terms of organizations or individuals competing with the licensed technology
cc. The rate that the technology in the technological area is advancing, ranging from pedestrian to very fast
dd. Competitive technology or IP in the markets prior to the date of licensing the technology
ee. The extent of improvement of the licensed technology on any existing technology
ff. The degree of innovation, ranging from improvement to a breakthrough
gg. Other technologies required to fully utilize the licensed technology (1 f not usable on its own)
hh. Ownership of improvements
ii. Responsibility for maintenance of patents.

FIG. 3, represented by numeral 301, represents another embodiment of the present invention. Specifically, a user 302 requests value of an IP asset 303. The information regarding the IP asset is passed to the blockchain network 304. The blockchain network deploys a smart contract 310 that pools data related to similar IP 305, and passes said information to the AI network 306. The AI network 306 analyzes the data to determine the value of the IP asset 307. The information is passed back to the blockchain network 304. The information is further passed from the blockchain network 304 to the IP owner 308 and the user 302. The IP owner can decide to license the asset to the user at the determined value 309.

The information contained in the decentralized database is input to an artificial neural network knowledgebase which, in turn is used to train the artificial neural network algorithms and application. The knowledgebase may comprise a physical database structure or may be a logical database structure contained within one or more other databases or links to such other databases. The same algorithms and artificial neural network application may additionally be used to train the intelligent agents, described above.

The normalized value and market value multiple are input to the artificial neural network software application along with the parameters extracted from the licensing agreement. These are then used to train the artificial neural network to predict a new value for a defined intellectual property or technology. In addition, the artificial neural network can assist in determining the structure of the licensing agreement and remuneration package.

Each new transaction that is input to and processed by the artificial neural network, in turn, is added to the Artificial Neural Network knowledgebase 38 and can then be used to configure the network and can then be selected as input for other new transactions.

The behavior of the individual parameters is stored within individual “neurons” within the network and described by mathematical functions. The predictive ability is stored within the structure and configuration of the “neurons” making up the artificial neural network and the type of optimizing behavior programmed into the network.

A theoretical adjusted normalized value can be calculated from the normalized value which is adjusted according to the agreement determinants, although this measure may have no real value meaning in absolute terms.

Artificial neural networks are software constructs modeled on the functioning of the human brain. The artificial neural network software application comprises a system of nodes, connected by links, each of which has a numerical weight associated with it. The weights represent the long-term storage of the network and learning occurs by updating the weighting factors connecting nodes in the network. Each node has a set of input links from other units, a set of output links to other units, a current activation level and a means of computing the activation level at every step in time. The weights in the network are initialized with some default value and then synchronously updated based on inputs over time. Each node receives input from its input links and performs a computation based on the values of the input signal received from each neighboring node and the value of the weight on the respective input link. It then performs a linear input function to compute the weighted sum of the node's input values followed by a non-linear activation function that transforms the weighted sum into the final value that serves as the node's activation value. Neural networks can be classified into two main types, feed-forward and recurrent networks, and there are also several different subtypes. These different networks have different features and may be more or less appropriate for different problems. The optimal network structure may be found by employing searching and learning techniques such as hill-climbing, simulated annealing or genetic algorithms. It is a common practice to vary the network type and the parameters of the weighting and activation functions contained in the nodes and links during the early stages of problem solving in order to evolve a network structure that works well for a particular problem domain.

In the present embodiment, the most likely network topology comprises a multi-layer feed-forward network in which there are three principle layers in the network, an input layer to receive input from the environment, an output layer to produce outputs and, in between, a layer of hidden nodes that connect nodes from the input layer to nodes in the output layer. In this specific configuration, the evolution of weights and consequent learning by the system can be driven by a technique known as back-propagation.

In one embodiment, the intake process and valuation engine maintains the confidentiality and ownership of the transaction data input in the system. The Valuation Engine can sit on or be built on top of Zuse or any another Patent Analytics software engine.

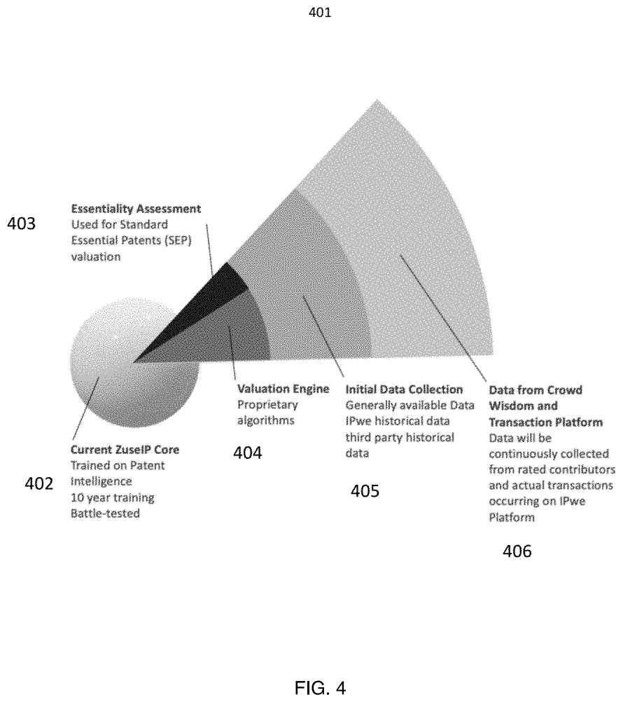

FIG. 4, represented by numeral 401, is one embodiment that envisions the present invention. Specifically, the embodiment envisions an AI platform such as Zuse Analytics 402, that is battle tested and 10 years old. The value engine itself uses proprietary algorithms 404, that are used to determine patent value. In addition, essentiality assessment 403 is used to score patent essentiality, i.e. the degree to which a device/solution practicing a standard necessarily infringes the patent. The initial data collection phase 405, makes up a portion of the embodiment. Finally, data from crowd or third party 406 wisdom is accounted for in the valuation of any IP.

The learning potential of the system applied to the artificial neural network is supplemented by a system of probabilistic learning using Bayesian learning, as discussed above. In the present embodiment, this technique is particularly useful for representing and reasoning with uncertain knowledge and the associated probabilities. Networks equipped with these kinds of learning characteristics are generally referred to as adaptive probabilistic networks.

In the present embodiment, a commercial artificial neural network software application can be purchased or, alternatively, a purpose-built application could be developed. In either case, it will be necessary to select appropriate algorithms from preexisting types and to configure the internal structure to suit the purpose. The network structure and the characteristics and parameters of the various algorithms and functions in the nodes, links and other components of the network must be evolved so as to optimally retain the knowledge contained in dissected licensing and sale agreements and accurately predict a fair value based on prior transactions.

In its simplest manifestation, the nodes of the artificial neural network will correspond directly to the valuation determinants, the links to the relationships that exist between determinants and the weighting on the links to the ratings and weightings assigned to the determinants. Actual and predicted normalized values are used as goals and feedback into the system, driving the learning function.

It is an important feature of the system that the feedback mechanism for the artificial neural network learning algorithms is provided by “done deals”. It is generally assumed that these provide the most accurate estimation of the fair value of the particular transaction as they are the result of an arm's length business negotiation process involving two parties with self-interest. Therefore, the task of the system is reduced to accurately storing this information bringing it to bear on the transaction at hand while normalizing and correcting for other factors influencing the normalized value whilst maintaining the normalized remuneration or value as a constant.

More specifically, according to the invention there is provided a method of valuing intellectual property, the method comprising: using a decentralized database to combine historical transaction data corresponding to a plurality of transactions relating to intellectual property;

normalizing the remuneration structure of specific transactions in order to extract normalized values thereof and storing said values in a second, market value database;

dissecting and analyzing the transaction data according to a predetermined scheme and storing the dissected and analyzed data in a third, determinants database;

evaluating the importance of selected determinants according to predetermined criteria to obtain ratings and weightings corresponding thereto, and storing the ratings and weightings in a fourth, ratings and weightings database;

compiling an artificial neural network knowledgebase, deployable on a blockchain, using information from the ratings and weightings database and other inputs;

extracting financial and market data from the transaction data and storing the extracted financial and market data in a fifth, financial database;

comparing stored data from the second, third, fourth and fifth databases and the artificial neural network knowledgebase with current transaction data, current market value data, and current financial and market data relating to a transaction under consideration, according to predetermined criteria, to identify similarities between the stored data and the said current data, thereby to generate an initial valuation model for the transaction under consideration; and

applying weightings, priorities and/or probabilistic criteria to the valuation model according to criteria related to the transaction under consideration to generate a final valuation model.

The method may include the steps of extracting conceptual data from the transaction data and storing the extracted conceptual data in a sixth, concepts database, and comparing stored data from the sixth database with current conceptual data relating to a transaction under consideration, according to predetermined criteria, when generating the initial valuation model.

The method may further include the steps of recording transaction data on the blockchain related to selected valuation methodologies and techniques, and facts and rules pertaining thereto, in an expert knowledgebase, and utilizing the stored data in generating the initial valuation model.

Preferably, the method comprises extracting the conceptual data from the transaction data by pattern matching, context analysis and/or concept extraction of noun phrases or concepts in the form of a “conceptual fingerprint” that characterizes similar transactions within the transaction database.

The method may include using the weightings and ratings of the determinants and the normalized values of the transactions to train algorithms in a software application of an artificial neural network by storing said weightings, ratings and normalized values in the configuration of the nodes of the network and using the application to predict the value of a new transaction.

The artificial neural network algorithms are programmable on a smart contract, when executed, they compare the ratings, weightings and normalized values assigned to valuation determinants to the normalized market value of a known transaction to predict a value for a transaction under consideration.

The comparison of stored data from the second, third, fourth and fifth databases and the artificial neural network knowledgebase with current transaction data, current market value data and current financial and market data relating to a transaction under consideration is preferably carried out utilizing artificial intelligence software for comparing noun phrases, concepts and/or keywords and tokens in order to search for and compare the stored data with current data relevant to the transaction under consideration.

Further according to the invention there is provided a system for valuing intellectual property, the system comprising:

a decentralized network, comprising transaction data corresponding to a plurality of transactions relating to intellectual property; the decentralized network related to intellectual property, further comprising databases related to:

market values and normalized values extracted from the remuneration structure of specific transactions;

dissected and analyzed data obtained by dissecting and analyzing the transaction data according to a predetermined scheme;

ratings and weightings data obtained by evaluating the importance of selected determinants according to predetermined criteria;

an artificial neural network knowledgebase comprising information from the ratings and weightings database and other inputs;

financial and market data extracted from the transaction data; and

a modeling and estimation module comprising an artificial neural network application arranged to compare stored data from the second, third, fourth and fifth databases and the artificial neural network knowledgebase with current transaction data, current market value data and current financial and market data relating to a transaction under consideration, according to predetermined criteria, to identify similarities between the stored data and the said current data, thereby to generate an initial valuation model for the transaction under consideration and further to apply weightings, priorities and/or probabilistic criteria to the initial valuation model according to criteria related to the transaction under consideration to generate a final valuation model.

Data related to transactions involving royalty rates, license fees and intellectual property valuations or sales as well as transfers concluded as part of a sale of a business.

The weightings and ratings attached to specific transaction determinants are preferably located within the second, determinants database or in a separate database associated with the artificial neural network application.

The system may include artificial intelligence software for comparing noun phrases, concepts and/or keywords and tokens in order to search for and compare the stored data with current data relevant to the transaction under consideration.

The artificial intelligence software is preferably operable to develop intelligent agents having a learning capability that can be used to search for similarities between transactions on a conceptual level and to order transactions according to such similarities, and thus to characterize transactions by means of a “conceptual fingerprint”.

The system may include an expert system comprising a knowledge base of facts and rules pertaining to valuation methods and an associated inference engine.

The fifth, financial database preferably contains data relating to relevant economic, industry, business and market information which may influence royalty rates, license fees or the value of intellectual property.

The system may be implemented as a web service on the Internet.

A block chain or blockchain is a distributed database that maintains a list of data records, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies such as used in bitcoin. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger.

The blockchain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person), and blocks are created by users known as “miners” who use specialized software/equipment to create blocks. In some embodiments, the block chain system disclosed, SS the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, that meets other criteria.

In one embodiment, the Network is made up of a plurality of nodes, each node connected to another node in the plurality of nodes, having the ability to pass data to each of the connected plurality of nodes. At least one node of the plurality of nodes is connected to an existing blockchain. Using this existing blockchain the, decentralized transactions can take place.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

As another example, a computer-readable medium comprising computer executable instructions for causing a client device to perform a method for device discovery and communication is provided, the method comprising broadcasting a request to identify a registry server, receiving a response from a registry server, and sending client update information to the registry server. The registry server is part of a registry group of the distributed hierarchical registry, where the registry group comprises a plurality of registry servers. The registry server updates other registry servers of the registry group with the client update information using, at least in part, a quorum consensus protocol.

In some embodiments, the system is further able to conserve network and computing resources by securely storing information associated with user data, preventing potential malicious activity involving such information, conserving bandwidth, memory, and computation resources.

A digital wallet is software and hardware (or specifically designed hardware) that allows an individual to make electronic commerce transactions that use, a blockchain. The digital wallet is a data structure that can include a private key (e.g., that is only known to the holder of the wallet) and a series of identifiers (sometimes called wallet identifiers, blockchain identifier, or walletIDs herein) that have been generated based on the private key. These identifiers are used to allow other users to “send” transactions, which are recorded on the blockchain, to that identifier. For example, the above novation process creates two blockchain transactions for a trade between Publisher (“Party A”) and the distributed decentralized network administrator (“Party B”). A first blockchain transaction may be from the wallet of party A to the wallet of the Party B. A second blockchain transaction may be from the wallet of the Party B to a wallet of party A. These transactions may be separately generated and submitted to the blockchain. Alternatively, the blockchain may only have one “wallet” that is being used for interacting with the blockchain. Other types of implementations may also be possible (e.g., where different parties, or their respective computer systems, use their own keys for a central blockchain). In certain embodiments, the wallets may be centrally managed by the distributed decentralized network computer system that the parties associated with the trade. However, the transactions recorded to the blockchain may still be signed by or otherwise associated with the individual wallets of the patent stakeholders.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

The present technology requires a data processing system with sufficient memory and processing power to store and recall user data in real time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups. In particular, the distributed decentralized network discussed herein must be capable of analyzing user and bid data in a manner that can optimize the bidding process.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating an architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of

What is claimed is:

1. A method for valuing Intellectual Property Assets, the method comprising: using a decentralized database to combine historical transaction data corresponding to a plurality of transactions relating to intellectual property;
deploying a smart contract to pool data related to specific IP transactions;
normalizing the remuneration structure of specific transactions in order to extract normalized values thereof and storing said values in a second, market value database;
dissecting and analyzing the transaction data according to a predetermined scheme;
evaluating the importance of selected determinants according to predetermined criteria to obtain ratings and weightings corresponding thereto;
compiling an artificial neural network knowledgebase, deployable on a blockchain, using information related the ratings and weightings;
extracting financial and market data from the transaction data;
updating the artificial neural network knowledgebase with current transaction data, current market value data, and current financial and market data relating to a transaction under consideration, according to predetermined criteria, to identify similarities between the stored data and the said current data, thereby to generate an initial valuation model for the transaction under consideration;
applying weightings, priorities and/or probabilistic criteria to the valuation model according to criteria related to the transaction under consideration to generate a final valuation model;

2. The method of claim 1, further comprising extracting conceptual data from the transaction data and storing the extracted conceptual data in the blockchain network.

3. A distributed network for valuing intellectual property assets, the network comprising:
a distributed network, the network comprising:
a plurality of nodes, wherein each node in the plurality of nodes is configured to transact autonomously with at least two nodes in the plurality of nodes and configured to communicate with at least one server;
the at least one server, the at least one server comprising at least one hardware processor, a non-transitory machine-readable storage medium having an executable computer readable program code, the at least one hardware processor configured to execute the computer-readable program code;
the server, capable of identifying at least one user using a private key and a public key and connected to an at least one user device;
the user device capable of communicating with the plurality of nodes;
the computer readable program code, configured to categorize an IP asset and pass historical information related to the IP asset to a neural network;
the neural network capable of deploying an algorithm, the algorithm used for analyzing the historical data based on a number of pre-defined categories,
the neural network further capable of outputting a valuation related to the IP asset to determine a value for the IP asset;
the neural network capable of passing the value related to the IP asset to the distributed network;

4. The distributed network of claim 3, wherein the network is a blockchain network;

5. The distributed network of claim 3, wherein the computer readable code is a smart contract;

6. The distributed network of claim 3, wherein the decentralized network is further capable of conducting transactions using FIAT currency;

7. The distributed network of claim 3, wherein the decentralized network is further capable of conducting transactions using cryptocurrency;

8. The neural network of claim 3, wherein the algorithm used to analyze the patent value is updated each time it is run;

9. The neural network of claim 3, wherein a third party may input additional information to update the algorithm;

10. A public ledger network comprising:
At least one hardware processor, a non-transitory machine-readable storage medium having an executable computer readable program code, the at least one hardware processor configured to execute the computer-readable program code to:
receiving, by the secure ledger network, a request to evaluate an IP Asset;
categorizing the IP asset;
obtaining information from available public and private sources related to the IP asset;
passing information related to the IP asset to a neural network;
the neural network configured to deploy an algorithm used to determine the value of the IP asset;
the value of the IP asset further passed to the public ledger network;
the ledger updated with the value of the IP asset;
the public ledger network further configured to deploy a smart contract;
the smart contract containing at least one rule related to the exchange of currency for an agreement to license or purchase the Intellectual Property asset;
when executed, the smart contract configured to transfer currency as determined by the rule.

11. The public ledger network of claim 10, wherein the network is a blockchain network.

12. The public ledger network of claim 10, further capable determining the owner of the intellectual property asset.

13. The public ledger network of claim 10, wherein the owner of the intellectual property asset can request its value.

14. The public ledger network of claim 10, wherein a third party can request the value of any intellectual property asset.

15. The public ledger network of claim 10, wherein the currency is cryptocurrency.

16. The public ledger network of claim 10, wherein the currency is FIAT currency.

17. The public ledger network of claim 10, further configured to pass data related to the IP asset to the neural network, the neural network further capable of updating the algorithm based on the data.
